(19) United States
(12) Patent Application Publication
(10) Pub. No.: US 2026/0236281 A1
(43) Pub. Date: Aug. 13, 2026

(54) GUI AND METHOD FOR COMMISSIONING DRIVES

(71) Applicant: Siemens AKtiengesellschaft, München (DE)

(72) Inventors: STEPHANIE KLIMA, Cadolzburg (DE); ANNA SUSLOVA, Erlangen (DE); MANUELA WIEDEMANN, Nürnberg (DE)

(73) Assignee: Siemens AKtiengesellschaft, München (DE)

(21) Appl. No.: 19/469,803

(22) PCT Filed: Mar. 14, 2024
(86) PCT No.: PCT/EP2024/056759

§ 371 Date: Sep. 26, 2025

(30) Foreign Application Priority Data
Mar. 28, 2023 (DE) 10 2023 202 830.1

(51) Int. Cl. G06F 9/451; G06F 3/0482; G06F 9/445

(52) U.S. Cl. CPC G06F 9/453; G06F 3/0482; G06F 9/44505; G06F 2203/04803

(57) ABSTRACT

A system for commissioning drives includes a memory for storing a machine-executable component, a processor that is coupled operatively to the memory and is designed to execute the machine-executable component, and a display device. The machine-executable component is designed as a commissioning tool for drives, and has a user guidance component that is designed to generate a sequence of configuration steps, for example at least two configuration steps, for commissioning at least one drive and to visualize the sequence of configuration steps in form of a non-modal wizard on the display device.

Independent of the grammatical term usage of a specific person-related term, individuals with male, female or other gender identities should be included within the term.

The present disclosure relates to a system for commissioning drives comprising a memory for storing at least one machine-executable component, a processor, which is operatively coupled to the memory and is configured to execute the at least one machine-executable component, and a display apparatus, wherein the at least one machine-executable component is designed as a commissioning tool for drives, especially for systems consisting of a converter, for example a frequency converter, and an electrical rotary machine, for example an electric motor.

Furthermore, the publication relates to a method for commissioning drives, and also to an engineering platform and a machine-readable medium.

The automation of processes and systems is an important element of many branches of industry. In order to make this automation possible engineering platforms are often used that make it possible for engineers to develop, test and implement applications.

An engineering platform for automation is a comprehensive software system that makes it possible for engineers and developers to plan, draft and Implement automation projects more effectively. As a rule such a platform comprises various tools for programming, testing, simulating and monitoring automation systems.

An important step in the implementation of automated systems is commissioning, in which various components of the system are tailored to one another in order to ensure that they function as planned. In this commissioning process the various components of the system can be linked to one another and put into operation, in order for example to test the functioning of the system as a whole and of its individual components.

In order to make the process of commissioning easier and to speed it up, specific tools are often employed. These tools can help to detect possible sources of errors at an early stage to rectify said errors, and to improve the efficiency of the system and shorten the commissioning time.

Such a commissioning tool for an engineering platform for automation could include a graphical user interface (GUI), which makes it possible for the user to put the system into operation step-by-step. The GUI could include various steps that the user has to perform in order to ensure that all components of the system are functioning correctly.

These steps could for example include the checking of the cabling, the calibration of sensors and actuators and also the setting up of closed-loop and open-loop controllers. The tool could also make test runs of the system possible, in order to ensure that it is functioning correctly and is delivering the desired results.

A further important aspect of such a tool could be the monitoring of the system. The tool could make possible a real time monitoring of the performance of the system and send the user notifications when problems arise. It could also collect and analyze data in order to give the user valuable insights into the performance of the system and demonstrate possible improvements.

A commissioning tool for an engineering-platform for automation could also offer a series of functions that facilitate the collaboration between various engineers and teams. It could for example offer a shared database for all system components in order to ensure that all those involved are up to date and have the latest information available to them.

Overall, a good commissioning tool for an engineering platform should have the following characteristics;
1. Simple configuration: The tool should make it possible, quickly and easily to configure and to connect the various components of the system. This can be achieved by an intuitive user interface and a simple drag-and-drop functionality.
2. Automated checking: The tool should be capable of carrying out automated checks in order to ensure that all components are functioning correctly and are correctly connected to one another. This can be achieved by the integration of diagnostic tools and by automated test functions.
3. Comprehensive documentation: The tool should be capable of creating comprehensive documentation about the system and its components. This makes it easier for engineers and developers to understand and to maintain the system.
4. Integration into the overall platform: The tool should be able to be integrated seamlessly into the overall platform in order to guarantee a smooth collaboration with other tools and components.

All in all an effective commissioning tool is indispensable for an engineering platform for automation, in order to speed up and to simplify the process of implementing automation projects. Such a tool should be simple to configure, offer automated checking and diagnostic tools, provide comprehensive documentation and be able to be integrated seamlessly into the overall platform.

A commissioning tool for drives that must be integrated into an automation system has a few special features that distinguish it from other commissioning tools. A few of these peculiarities will be described below:
Compatibility with the automation system: The commissioning tool is preferably compatible with the automation system into which the drive is to be integrated. It should be capable of reading and writing the configuration settings of the drive that will be needed by the automation system.
Configuration of drive parameters: A commissioning tool for drives is preferably capable of configuring the parameters of the drive. This comprises the setting of speed, torque, acceleration, brake and other relevant parameters.
Diagnosis of errors: The commissioning tool is preferably capable of reading and interpreting diagnostic data from the drive. This helps in the identification of errors and problems during the commissioning. The tool should also be capable of generating error codes and error messages in order to make troubleshooting easier.
Realtime monitoring: The commissioning tool should be capable of reading and displaying real time data from the drive. This makes it possible to rapidly check the performance and the behavior of the drive during commissioning.
Interfaces with other automation components: A commissioning tool is preferably capable of communicating with other components of the automation system. This comprises Integration with the controller, other drives, sensors and other components.
User friendliness: The commissioning tool should be user friendly and have an intuitive user interface. It should be simple to operate and make it possible for the user to Interact quickly and efficiently with the drive.

Overall, a commissioning tool for drives that must be integrated into an automation system should offer a comprehensive suite of functions, which make it possible for the user to commission and to monitor the drive rapidly and efficiently. It should also be capable of communicating with other components of the automation system and of making possible a seamless integration.

User friendliness is an important factor for a commissioning tool for drives, since it makes it possible for the users to use the functions of the tool quickly and easily. Given below are a few aspects that can contribute to user friendliness.

A commissioning tool can comprise an intuitive user interface. An Intuitive user interface can for example make the operation of the commissioning tool easier. The user interface should be easy to understand, so that the user can navigate quickly and efficiently.

The configuration of the commissioning tool should be simple and make it possible for the user to make the settings needed quickly and easily. A well-designed user interface can help to simplify the configuration.

The commissioning tool should moreover be available on various platforms, for example on PCs, tablets and mobile devices. This makes it possible for users to use the tool with the platform that is most convenient for them.

In summary, a user-friendly commissioning tool for drives makes the configuration and monitoring of the drive easier. It should have an intuitive user interface, be easy to configure and offer support for various languages and platforms. Comprehensive documentation and support resources can contribute to users being able to work quickly and effectively with the tool.

Commissioning tools for drives are known from the prior art. For example such tools can have a user interface in the form of a modal wizard.

A modal wizard makes it possible for users to carry out interactive steps in order to achieve a specific objective. This can be undertaken in the form of dialog fields, buttons, dropdown lists and other interactive elements.

The modal wizard guides the user through a sequence of steps, which are often referred to as “wizard steps”. As a rule each step is shown on a separate page and guides the user through a specific task or choice.

Wizards are often employed to help users in carrying out complex tasks that demand a series of settings or options.

In order to enhance the flexibility of the commissioning of the drives, a system of the type stated above is proposed, in which the commissioning tool has a user guidance component, which is configured to generate a series of configuration steps comprising at least two configuration steps for commissioning at least one drive and to visualize the series of configuration steps in the form of a non-modal wizard by means of the display apparatus.

A non-modal wizard makes it possible for the user to interrupt or to leave each individual configuration step before it is concluded. Thus, the non-modal wizard is less stringent as regards the order, so that the user is always flexible with regard to the order of the settings. In this case the user can make each change in the setting in a simple way.

In this case the user guidance component does not block the entire commissioning tool, as can be the case with other wizards, so that the user can switch to other programs within the engineering platform.

In one form of embodiment there can be provision for the user guidance component to be configured, based on data, which for example directly characterizes at least one drive or an application provided for the at least one drive/an operation, to preset at least one parameter value in at least one of the configuration steps.

In this case the user can work much more efficiently, because values are preset and the user does not have to do everything manually but must merely check the settings made automatically.

In one form of embodiment there can be provision for the user guidance component to be configured to generate a series of configuration steps optimized with respect to the time of the commissioning.

In one form of embodiment there can be provision for the user guidance component to be configured, by means of the non-modal wizard visualized on the display apparatus, to interact with a user, to ask the user questions, to receive inputs from the user as a reaction to the questions and to accept the inputs as settings for the at least one drive.

In this case it can be expedient for the user guidance component to be configured to visualize each configuration step of the series of configuration steps in the form of a clickable area on the display apparatus, wherein different configuration steps correspond to different, non-overlapping areas.

In such cases there can advantageously be provision for the user guidance component to be configured, when one of the clickable areas is clicked on, to visualize a question directed to a user on the display apparatus, wherein the question relates to that configuration step that corresponds to the area clicked on.

In this case there can be provision for the question to contain a request that the configuration step be carried out.

Furthermore, the flexibility of the commissioning of the drives can be enhanced with a method given at the outset, when said method has the following steps,
Provision of a (virtual or real) drive,
execution of a user guidance component in a commissioning tool for drives able to be operated via a display apparatus, in order to generate a comprehensive series of configuration steps for commissioning of the drive having at least two configuration steps and to visualize the series of configuration steps in the form of a non-modal wizard on the display apparatus,
execution of the configuration steps by using the non-modal wizard in order to configure the drive.

In this case there can advantageously be provision, during execution of a configuration step, for the user guidance component to preset a parameter value based on data that characterizes the at least one drive or an application provided for the at least one drive/an operation (for example directly) in the configuration step and, preferably, requests a user to confirm the at least one preset parameter value or to enter a value that differs from the at least one preset parameter value.

In one form of embodiment there can be provision for the configuration steps to be executed in an interaction with a user, wherein the user is guided by the non-modal wizard through the configuration steps, wherein the user guidance component asks the user questions, receives inputs from the user as a reaction to the questions and accepts the inputs as settings for the at least one drive.

The commissioning can furthermore be designed more flexibly with an engineering platform that comprises: at least one machine-executable component, which is embodied as a commissioning tool for drives, wherein the commissioning tool has a user guidance component, which is configured to generate a comprehensive series of configuration steps comprising at least two configuration steps for commissioning at least one drive and to visualize the series of configuration steps in the form of a non-modal wizard by means of the display apparatus.

The invention will be explained in more detail below with the aid of exemplary embodiments. In the figures:

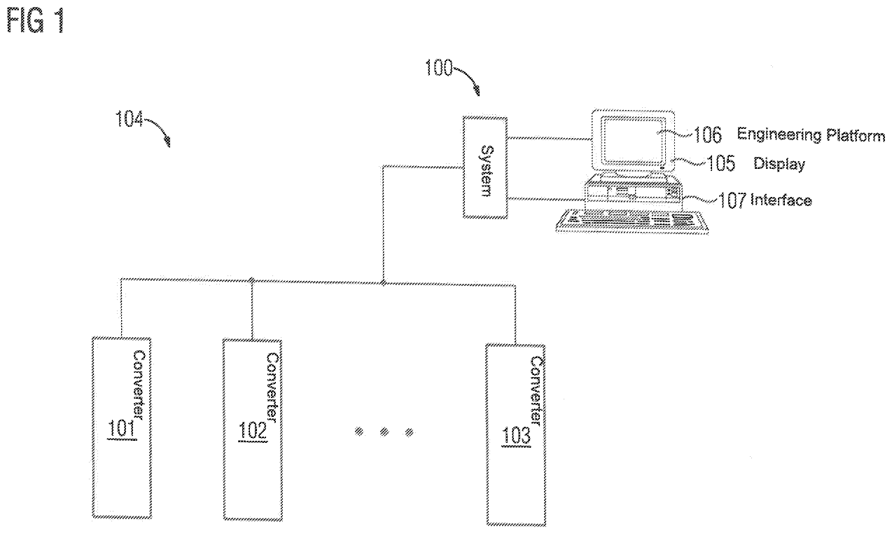

FIG. 1 shows a system for commissioning a number of converters,

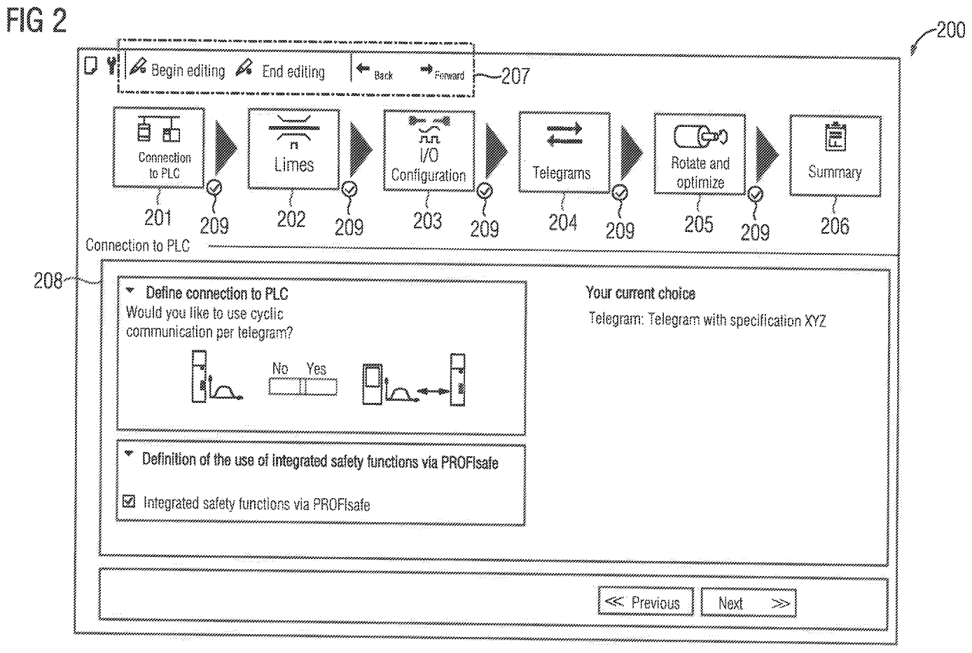

FIG. 2 shows a non-modal wizard, and

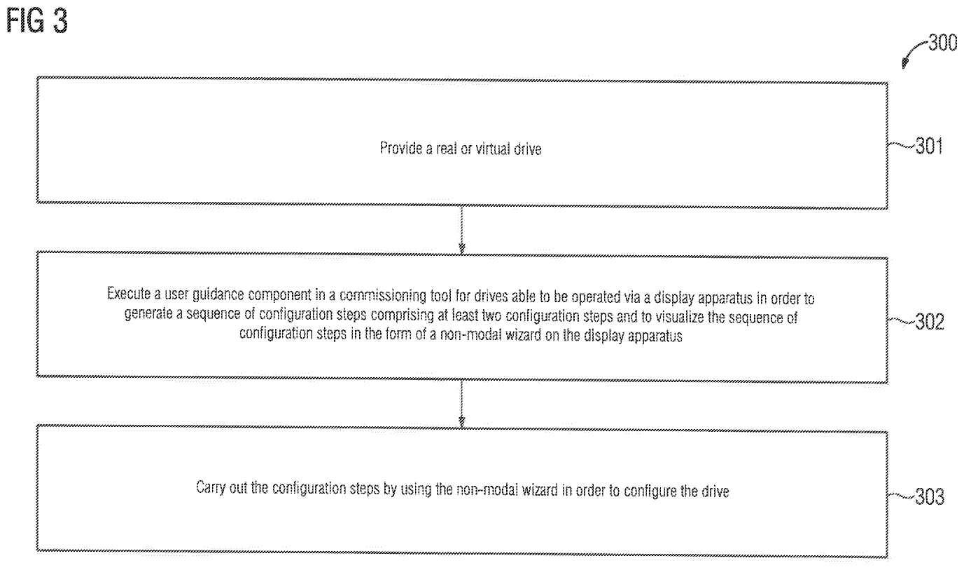

FIG. 3 shows a method for commissioning converters.

The reference numbers used in the figures serve exclusively to improve the readability and are not to be construed as restrictive. The same reference numbers in different figures refer to elements or subject matter that are or is essentially the same.

FIG. 1 shows a system 100 for commissioning a number of converters 101, 102, 103 in an automation plant 104. The system 100 is designed as a computer system and can for example monitor and control technical processes in an automated production system.

One or more of the converters 101, 102, 103, which can be embodied as frequency converters for example, can for example be connected to a load, such as an electric rotating machine for example (not shown here). Such a machine can drive an axis of a machine tool or a conveyor belt for example.

For the commissioning of the one or more converters 101, 102, 103 an engineering platform 106, which has a display apparatus 105 in the form of a screen, for example, is installed on the system 100. The engineering platform 106 in the present case comprises a commissioning tool for converters.

In addition, the system 100 is equipped with an interface 107, via which a user can operate the engineering platform 106 and in particular the commissioning tool. This can be embodied as a keyboard and a mouse, for example.

The commissioning tool comprises an executable user guidance component, which can be executed during commissioning of the converters 101, 102, 103.

When the user guidance component is executed, said component generates a series of configuration steps, which comprises at least two configuration steps. When the configuration steps are executed the corresponding converters 101, 102, 103 are configured and put into operation.

The user guidance component visualizes the series of configuration steps in the form of a non-modal wizard on the display apparatus 105, in order to make it possible for the user to undertake the configuration of the converter 101, 102, 103.

FIG. 2 shows a non-modal wizard 200. The figure shows a series of configuration steps with a total of six wizard steps 201, 202, 203, 204, 205, 206. In addition, the non-modal wizard 200 has a navigation menu 207. With the aid of the menu 207 the user can navigate to the individual wizard steps and edit these or end the editing.

A series of configuration steps is shown, which is optimized in respect of the commissioning time and makes possible the fastest possible commissioning of a converter.

The individual configuration steps 201, 202, 203, 204, 205, 206 are visualized in the form of clickable areas on the display apparatus 105 and can be in the form of tiles, for example.

It can be seen from FIG. 2 that the first wizard step 201 has been clicked on and that this involves the process of defining a connection to a PLC (Programmable Logic Controller).

As a reaction to being clicked on by a user—request—the user guidance component can visualize an area 208 on the display apparatus, in which actual configurations corresponding to the configuration step activated by the user are shown.

The menu 207, the wizard steps 201 to 206 and the area 208 are preferably visualized at the same time.

The user guidance component in this case generates predefined questions and/or sets prespecified settings and/or parameters to a predetermined value and visualizes these in the area 208.

FIG. 2 shows an example in which the setting “safety-integrated functions via PROFIsafe” has already been activated and the use of a specific telegram with specification “XYZ” is preset.

Each configuration step in which the settings have been completely made and/or are already preset can be marked in the non-modal wizard 200, by means of a status icon 209, for example.

These settings and/or the preset values correspond to a fully comprehensive functioning configuration of the converter 101, 102, 103. By accepting the proposed settings and/or the preset value the user can carry out the commissioning most rapidly. As an alternative, the user can change the settings and/or the preset values.

In addition, there can be provision, if specific settings in the configuration steps influence one another and this can lead to an adverse situation or to an error for example, for a further status icon in the navigation to indicate to the user where (in which configuration step 201 to 206) data still has to be checked.

FIG. 3 shows a flow diagram of a method 300 for commissioning at least one drive, for example one of the converters 101, 102, 103 of FIG. 1.

In a step 301 a converter is provided. This can also involve a virtual converter, i.e. a digital twin of a converter. The converter is to be put into operation by means for example of commissioning tools for drives able to be operated via the display apparatus 105.

For this purpose, in a step 302, a user guidance component is executed in the commissioning tool in order to generate a series of configuration steps comprising at least two configuration steps, for example the sequence depicted in FIG. 2 with six steps 201 to 206. The series of configuration steps is used for commissioning the converter and is visualized in the form of a non-modal wizard, see FIG. 2 for example, on the display apparatus.

Subsequently the individual configuration steps are carried out using the non-modal wizard in order to configure the drive. In this case the user, due to the non-modality of the wizard, can switch between the individual steps as they wish.

To summarize, the present document discloses a commissioning tool with an improved user guidance. In this case the system guides the user by using a non-modal wizard through the most important steps of the configuration, commissioning and diagnosis. In this case any other tool can be opened within the engineering platform, in order for example to check specific data. The system fills out further values, depending on user application and inputs. The steps (commissioning steps) can be carried out by the user both sequentially and also flexibly by users in any given order. Rapid changes are thus possible. However, there is also guidance through the steps that the user can adhere to. This has advantages of flexibility and speed of carrying out the process for both inexperienced and experienced users.

The object of this description merely consists in providing illustrative examples and specifying further advantages and special features of this invention. Thus, it cannot be interpreted as restricting the area of application of the invention or of the patent rights claimed in the claims. In particular the features disclosed here in conjunction with the method described here can sensibly be employed for developing the apparatuses employed here and vice versa.

What is claimed is:

1.-12. (canceled)

13. A system for commissioning drives, comprising:
a memory for storing at least one machine-executable component embodied as a commissioning tool for drives, with the commissioning tool including a user guidance component designed to generate a series of configuration steps having at least two configuration steps for commissioning at least one of the drives,
a processor operatively coupled to the memory and designed to execute the at least one machine-executable component, and
a display apparatus designed to visualize the series of configuration steps in form of a non-modal wizard which allows a user to interact with the user guidance component visualized on the display apparatus by asking the user a question, receiving inputs from the user in response to the question and accepting the inputs as settings for the at least one drive,
wherein the user guidance component is designed to visualize each configuration step of the series of configuration steps in form of a clickable area on the display apparatus, with different configuration steps corresponding to different non-overlapping areas, and, when one of the clickable areas is clicked on, to visualize the question directed to the user on the display apparatus and relating to a configuration step of the series of configuration steps that corresponds to the clicked-on area, wherein the question contains a request to carry out the configuration step.

14. The system of claim 13, wherein the user guidance component is designed, based on data that characterize the at least one drive or that characterize an application provided for the at least one drive or an operation of the at least one drive, to preset at least one parameter value in at least one of the configuration steps.

15. The system of claim 13, wherein the user guidance component is designed to generate a series of configuration steps optimized in respect of a time of the commissioning.

16. A method for commissioning drives, comprising:
providing a drive,
executing a user guidance component in a commissioning tool for drives operable via a display apparatus for generating on the display apparatus a series of configuration steps having at least two configuration steps for commissioning of the drive and for visualizing the series of configuration steps in form of a non-modal wizard,
executing the configuration steps by using the non-modal wizard, and
configuring the drive.

17. The method of claim 16, further comprising when a configuration step is carried out, presetting with the user guidance component, based on data that characterize the drive or that characterize an application provided for the drive or an operation of the drive, at least one parameter value in the configuration step.

18. The method of claim 17, further comprising requesting a user to confirm the at least one preset parameter value or to input a parameter value differing from the at least one preset parameter value.

19. The method of claim 16, further comprising:
performing the configuration steps in an interaction with a user by guiding the user through the configuration steps by the non-modal wizard,
asking the user questions with the user guidance component, and
receiving from the user inputs in response to the questions and accepting the inputs as settings for the drive.

20. An engineering platform comprising at least one machine-executable component embodied as a commissioning tool for drives, with the commissioning tool comprising a user guidance component designed to generate a series of configuration steps comprising at least two configuration steps for commissioning at least one of the drives, and to visualize the series of configuration steps in form of a non-modal wizard by way of a display apparatus.

21. A computer-program embodied on a non-transitory computer-readable medium and comprising computer instructions which when read into a memory of the engineering platform of claim 20 and executed by a processor of the engineering platform cause at least one machine-executable component of the engineering platform embodied as a commissioning tool for drives to generate with a user guidance component a series of configuration steps comprising at least two configuration steps for commissioning at least one of the drives, and to visualize the series of configuration steps in form of a non-modal wizard by way of a display apparatus.
